(19) United States
(12) Patent Application Publication
(10) Pub. No.: US 2010/0214623 A1
(43) Pub. Date: Aug. 26, 2010

(54) IMAGE READING DEVICE AND IMAGE FORMING APPARATUS

(75) Inventor: Mitsuo SHIMIZU, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD, Tokyo (JP)

(21) Appl. No.: 12/569,949

(22) Filed: Sep. 30, 2009

(30) Foreign Application Priority Data
Feb. 26, 2009 (JP) 2009-044118

(51) Int. Cl. H04N 1/00

(52) U.S. Cl. 358/406

(57) ABSTRACT

There is provided an image reading device including: a light source; an image forming unit including plural optical members that receive reflection light reflected from the document and form an image from the received light; plural light receiving units that receive the light formed into an image by the image forming unit and convert the light to an electric signal; a storing unit that stores plural kinds of correction data; a detecting unit that detects an amount of relative positional shift between a light receiving unit and the image forming unit for each light receiving unit; and a correcting unit that selects correction data suitable for each light receiving unit from the plural kinds of correction data stored in the storing unit based on the detected amount of relative positional shift, and corrects the electric signal converted by each light receiving unit based on the correction data.

### CROSS-REFERENCE TO RELATED APPLICATION

This application claims priority under 35 USC 119 from Japanese Patent Application No. 2009-044118 filed on Feb. 26, 2009.

### BACKGROUND

### Technical Field

The invention relates to an image reading device and an image forming apparatus.

### SUMMARY

There is provided an image reading device and an image forming apparatus capable of preventing a reading quality from deteriorating due to relative positional shift between a light receiving unit and an image forming unit even when an amount of relative positional shift between the light receiving unit and the image forming unit is different for each light receiving unit.

An image reading device according to a first aspect of the invention includes: a light source for irradiating light to a document; an image forming unit including plural optical members for receiving reflection light reflected from the document and forming an image of the received light; plural light receiving units for receiving the light that forms an image by the image forming unit to convert to an electric signal; a storing unit for storing plural kinds of correction data used for correcting the electric signal converted by the light receiving unit; a detecting unit for detecting an amount of relative positional shift between the light receiving unit and the image forming unit for each light receiving unit; and a correcting unit for selecting correction data suitable for each light receiving unit from the plural kinds of correction data stored in the storing unit based on the amount of relative positional shift detected by the detecting unit, and correcting the electric signal converted by the light receiving unit based on the correction data.

### BRIEF DESCRIPTION OF THE DRAWINGS

Exemplary embodiments of the present invention will be described in detail based on the following figures, wherein:

FIG. 1 is a cross-sectional view showing an image reader adopted in an image reading device according to an exemplary embodiment of the invention;

FIG. 2 is a perspective view showing a lens array of the image reader adopted in the image reading device according to the exemplary embodiment of the invention;

FIG. 3 is a schematic configuration diagram showing the image reading device according to the exemplary embodiment of the invention;

FIG. 4 is a view showing shading correction data used in the image reading device according to the exemplary embodiment of the invention as a graph;

FIG. 5 is a flow diagram showing a flow to execute the shading correction in the image reading device according to the exemplary embodiment of the invention; and

FIG. 6 is a schematic configuration diagram showing the image forming apparatus adopting the image reading device according to the exemplary embodiment of the invention.

### DESCRIPTION

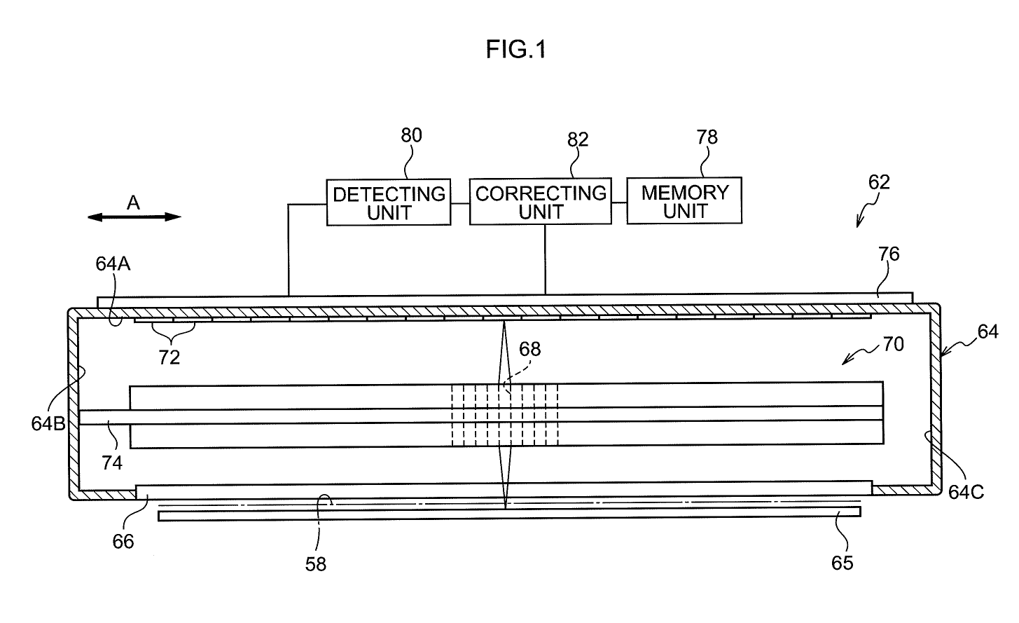

An example of an image forming apparatus 100 adopting an image reading device 10 according to an exemplary embodiment of the invention is described with reference to FIGS. 1 to 6.

(Entire Configuration)

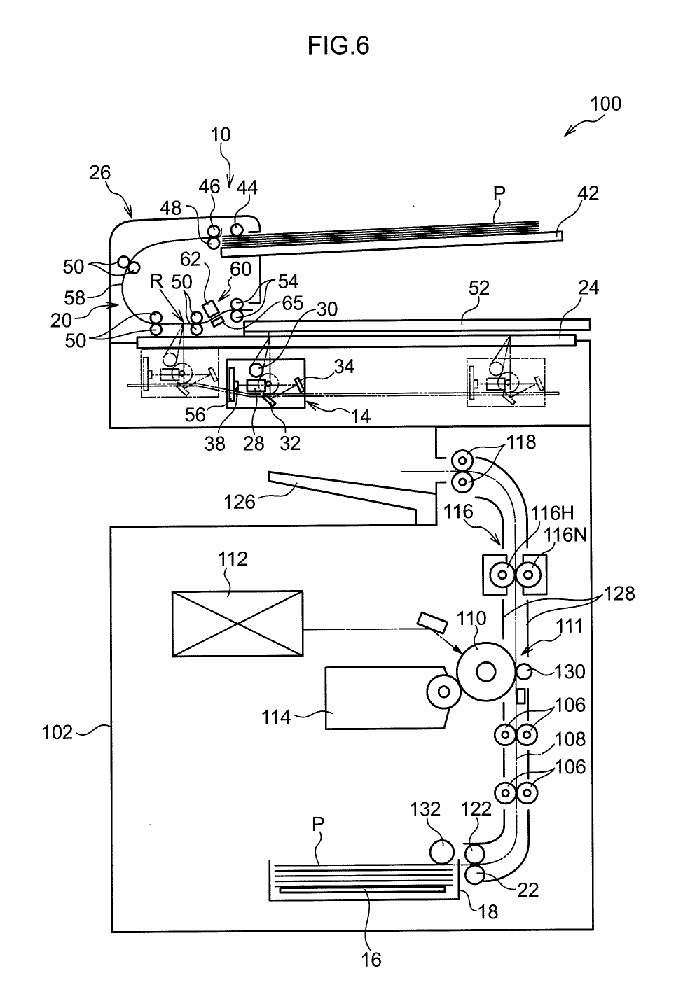

As shown in FIG. 6, a paper-feed cassette 18 is provided on a lower portion in a casing 102 of the image forming apparatus 100. A sheet member P to be fed to an image forming unit 111 of the image forming apparatus 100 is loaded on the paper-feed cassette 18.

A bottom plate 16 on which the sheet member P is put is provided on the paper-feed cassette 18, and when feeding the sheet member P to the image forming unit 111, the bottom plate 16 moves upward by a lifting unit (not shown). The paper-feed cassette 18 is configured to press the upper most sheet member P put on the bottom plate 16 against a pick-up roll 132. When the paper-feed cassette 18 is pulled out from the casing 102, the bottom plate 16 moves downward by the lifting unit, thereby storing the sheet member P in the paper-feed cassette 18.

Also, on a downstream side of the pick-up roll 132 in a sheet member conveying direction, a paper-feed roll 122 and a separation roll 22 for separating the sheet member P sent by the pick-up roll 132 one by one to convey are disposed.

Conveyance rolls 106 are arranged on predetermined positions in the casing 102 to compose a conveyance path 108 for conveying the sheet member P. Also, guide members 128 for guiding the sheet member P along the conveyance path 108 are provided on both side of the conveyance path 108. Meanwhile, hereinafter, when simply referred to “upstream” and “downstream”, they are intended to mean upstream and downstream in the sheet member conveying direction, respectively.

Also, in the middle of the conveyance path 108, a photoreceptor drum 110 is disposed so as to be in contact with the sheet member P, and this is configured to rotate while being in contact with the sheet member P. A charging device (not shown) for charging a surface of the photoreceptor drum 12 is provided so as to be adjacent to the photoreceptor drum 12.

Also, an exposure device 112 for forming an electrostatic latent image on the surface of the photoreceptor drum 110 by irradiating a laser beam according to image information on the surface of the photoreceptor drum 110 charged by the charging device not shown is provided. A developing device 114 for visualizing the electrostatic latent image as a toner image is disposed so as to be adjacent to the photoreceptor drum 110.

A transfer roll 130 for forming the image forming unit 111 together with the photoreceptor drum 110 is disposed so as to be opposed to the photoreceptor drum 110. The transfer roll 130 sandwiches the sheet member P between the same and the photoreceptor drum 110 to closely adhere to the sheet member P to be conveyed. By this, the toner image on the photoreceptor drum 110 is transferred to the sheet member P, and an image is formed on the sheet member P.

A fusing device 116 provided with a heating roll 116H with a heater inside thereof and a pressurizing roll 116N, which is brought into contact with the heating roll H with pressure, is disposed on a downstream side of the photoreceptor drum 110. The two rolls sandwich the sheet member P to convey, thereby heating the sheet member P, and the toner image on the sheet member P is fused to the sheet member P.

Also, a discharge roll 118 is disposed on a downstream side of the fusing device 116, and the sheet member P to which the toner image is fused is discharged to a discharge tray 126 provided above the casing 102 by the discharge roll 118.

(Substantial Part Configuration)

The image reading device 10 for reading the image information of the document sheet member P is provided above the discharge tray 126. The image reading device 10 is provided with a platen glass 24 as a glass plate on which the document sheet member P is put.

A platen cover 26 as a document pressing member, which covers the platen glass 24 so as to be opened and closed, is provided on an upper side of the platen glass 24. An automatic document conveying device 20 for automatically conveying plural documents as a set to a document reading position R above the platen glass 24 is provided in the platen cover 26.

A reading unit 14 for reading the image information of the document sheet member P put on the platen glass 24 and the image information of a surface of the document sheet member P conveyed to the document reading position R by the automatic document conveying device 20 is provided on an image reading device main body 10A in which the platen glass 24 is fit.

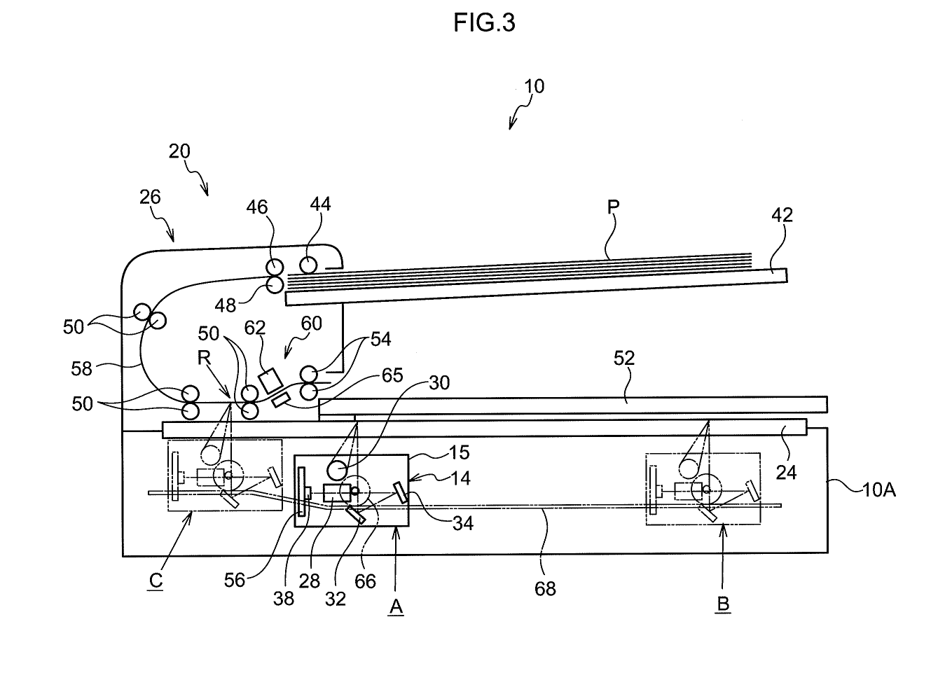

As shown in FIG. 3, a pick-up roll 44 for sequentially sending the plural document sheet members P put on a document tray 42 provided on an upper portion of the platen cover 26, and a paper-feed roll 46 and a separation roll 48 for conveying the document sheet member P, which is sequentially picked up by the pick-up roll 44, one by one are provided on an automatic document conveying device 20 (ADF device) provided in the platen cover 26.

Plural conveyance rolls 50 for allowing the document sheet member P, which is sent to the conveyance path 58 by the paper-feed roll 46 and the separation roll 48, to pass through the document reading position R above the platen glass 24 are provided.

Also, an image reading device 60 for reading the image information of a rear surface of the document sheet member P is provided on a downstream side of the conveyance path 58. A discharge roll 54 for discharging the conveyed document sheet member P to a second discharge tray 52 provided above the platen glass 24 is provided on a downstream side of the image reading device 60. Meanwhile, a detail of the image reading device 60 is to be described later.

On the other hand, the reading unit 14 for reading the image information of the document sheet member P from a lower surface of the platen glass 24 is provided on a lower side of the platen glass 24. A light source 30 for irradiating light on the surface of the document sheet member P, planar mirrors 32 and 34 for reflecting reflection light reflected from the document sheet member P to a predetermined position, and an image forming lens 28 for forming an image of the light reflected by the planar mirrors 32 and 34 on a photoelectric conversion element 38 are provided in a casing 15 of a rectangular parallelepiped-shape reading unit 14, which extends in a sheet member width direction (depth direction of the image forming apparatus 10 in FIG. 3). The photoelectric conversion element 38 converts the light, from which an image is formed, to an electric signal and sends the image information to the exposure device 112 through a reading circuit substrate 56. Also, a moving unit (not shown) for moving the reading unit 14 in a longitudinal direction of the sheet member (right and left direction in FIG. 3) along the platen glass 24 is provided.

By this configuration, when reading the image information of the document sheet member P put on the platen glass 24, the reading unit 14, which moves between positions A and B along the platen glass 24, reads the image information of the document sheet member P. On the other hand, when reading the image information of the surface of the document sheet member P sent to the document reading position R by the automatic document conveying device 20 (ADF device), the reading unit 14 moved from the position A to a position C reads the image information of the surface of the document sheet member P, which passes through the document reading position R.

Next, a configuration to read the image information of the rear surface of the document sheet member P sent to the document reading position R by the automatic document conveying device 20 (ADF device) is described.

The image reading device 60 for reading the image information of the rear surface of the document sheet member P is provided with an image reader 62 and a reference white plate 65 as an irradiated member, which is arranged so as to be opposed to the image reader 62 with the conveyance path 58 interposed therebetween.

As shown in FIG. 1, the image reader 62 has a rectangular parallelepiped-shape casing 64, and in the casing 64, a planar dust-proof glass 66 formed of a material, which transmits light, such as glass is mounted on a plane opposed to the conveyance path 58. Also, a light source (not shown) for irradiating light on the rear surface of the document sheet member P is provided in the casing 64.

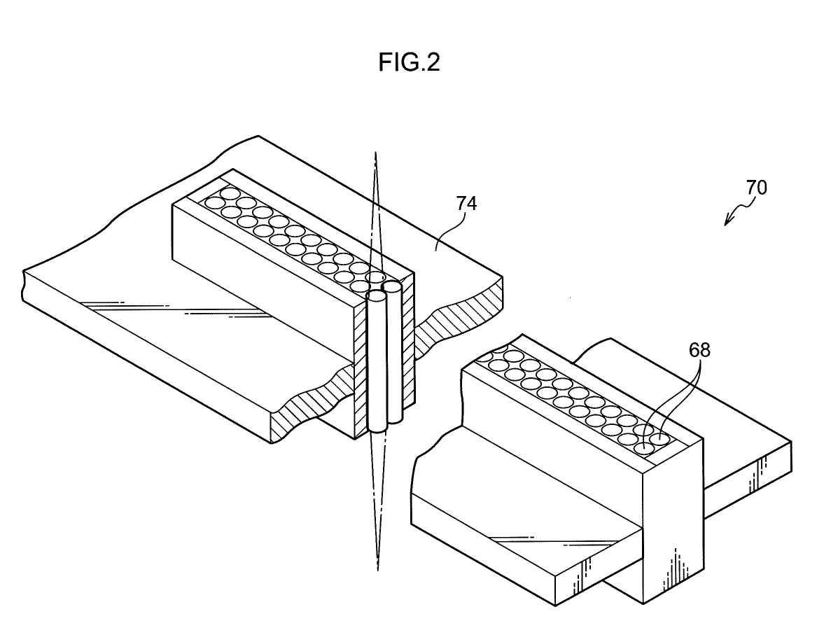

A lens array 70 as image forming unit provided with plural rod lenses 68 (refer to FIG. 2) as optical members for receiving the reflection light reflected from the document sheet member P obtained by irradiating the light from the light source to the document sheet member P and forming an image of the received light is provided. One end of the lens array 70 is fixed to a side plate 64B of the casing 64 with a planar fixture 74.

Also, plural (16 to 24 in this exemplary embodiment) planar light receiving members 72 provided with plural reading pixels (300 to 400 pixels in this exemplary embodiment) for forming the light, which forms an image by the lens array 70, are provided. The light receiving member 72 is configured to convert the received light to the electric signal, and the plural light receiving members 72 are tightly-arranged to form a line across at least a width (substantially 300 mm in consideration of A3 size sheets in this exemplary embodiment) of the maximum document sheet member P in a fast scanning direction of the document (arrow A direction in FIG. 1). A substrate 76 for sending the electric signal converted by the light receiving member 72 to the exposure device 112 is provided so as to be opposed to the light receiving members 72 with a top plate 64A of the casing 64 interposed therebetween.

The reference white plate 65 provided so as to be opposed to the image reader 62 is used as a portion to be irradiated, and forms a part of detecting unit for detecting an amount of relative shift of the rod lens 68 to be described later to the light receiving member 72. Examples of the reference white plate 65 to be used include a white film.

As shown in FIG. 2, the lens array 70 has plural cylindrical rod lenses 68 each having a refraction distribution in a radial direction, which are arranged so as to form a double line, for example, in the fast scanning direction such that light axes of the plural rod lenses 68 are parallel to one another. In addition, spaces formed between each of the rod lenses 68 and spaces formed between each of the rod lenses 68 and the fixture 74 are filled with black resin. Meanwhile, each of the rod lenses 68 is formed of an erecting equal-magnification lens.

Herein, as shown in FIG. 1, in the image-reader 62, the light receiving members 72 and the lens array 70 are attached to the casing 64, as described above.

In detail, the light receiving members 72 are fixed to the top plate 64A of the casing 64. Therefore, considering based on one side plate 64B of the casing 64, for example, when the light receiving members 72 are thermally expanded by heat emitted from the light source during irradiation of the light and the like, the light receiving members 72 are configured to thermally-expand so as to extend to a side of another side plate 64C based on the side plate 64B.

On the other hand, the lens array 70 also is fixed to the side plate 64B by means of the fixture 74. Therefore, when the lens array 70 is thermally expanded by the heat emitted from the light source during the irradiation of the light, for example, the lens array 70 thermally expands so as to extend to the side of the side plate 64C based on the side plate 64B.

A material of the light receiving member 72 and a material of the rod lens 68 or the like to compose the lens array 70 are generally different from each other, and coefficients of thermal expansion thereof are different from each other, so that lengths of extension of the light receiving member 72 and the lens array 70 by the thermal expansion are different from each other even under the same temperature. Therefore, when the temperature changes, relative change (shift) occurs in a positional relationship between the rod lens 68 and the light receiving member 72 due to the different coefficients of thermal expansion, and linear irregularity in the fast scanning direction might occur in the read image.

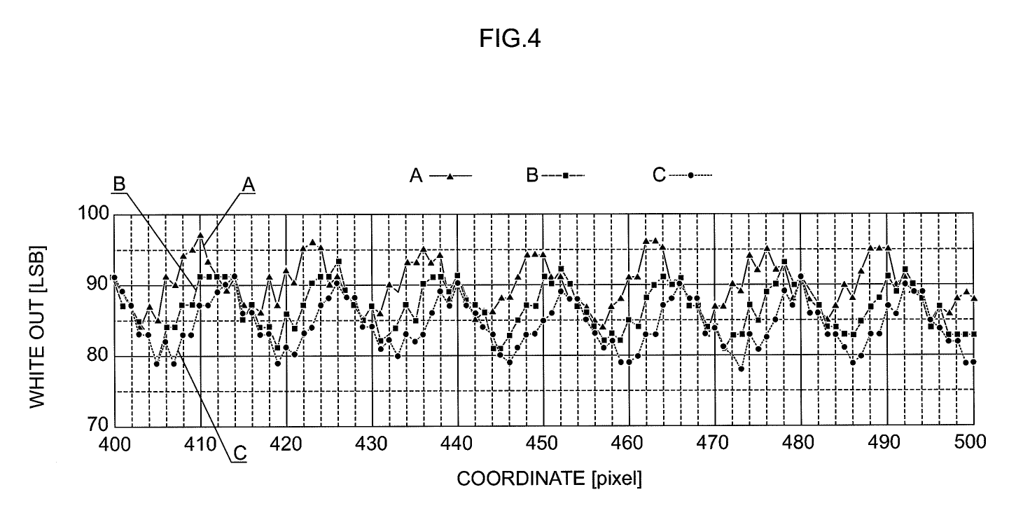

FIG. 4 is a graph showing a relationship between an actual position of the image in the fast scanning direction (horizontal axis) and an output by the light receiving member 72 (vertical axis) when reading the reflection light from the reference white plate 65 by the image reading device 10 in temperature environments of 0° C., 30° C. and 60° C. Broken curves A, B and C represent graphs of 0° C., 30° C. and 60° C., respectively, and the horizontal axis indicates the position in the fast scanning direction in reading pixel units.

A principal cause of occurrence of the irregularity with a predetermined cycle in the output from the light receiving member 72 as shown in FIG. 4 is that the rod lenses 68 are arranged in the fast scanning direction at a predetermined pitch. That is to say, since intensity of the light irradiated from the rod lens 68 to a light receiving sensor 226 of the light receiving member 72 is different according to a distance from the optical axis of the rod lens 68, the irregularity with the predetermined cycle occurs in the output from the light receiving member 72 in the fast scanning direction. That is to say, the cycle of the output irregularity in the graph shown in FIG. 4 has a relationship with an outer diameter of the rod lens 68. In addition to this, it is also understood that a peak position of the cycle of the output irregularity shifts depending on the temperature environment. The broken curves A, B and C shift in a horizontal axis direction of the graph in FIG. 4, and the peak position of the cycle of the output irregularity differs according to the temperature.

A reason why the peak position of the cycle of the output irregularity shifts according to the temperature is that the difference in thermal expansion between the light receiving member 72 and the lens array 70 changes according to the temperature, and thereby an amount of positional shift occurring between the optical axis of the rod lens 68 and the light receiving member 72 is different. That is to say, the peak position of the cycle of the output irregularity shifts according to the temperature environment in the light receiving member 72.

The plural light receiving members 72 are arranged in the fast scanning direction in one image reader 62, and the peak position of the cycle of the output irregularity might shift in the light receiving members 72 also. That is to say, this is because the amount of positional shift occurring between the optical axis of the rod lens 68 and the light receiving member 72 is different between the light receiving member 72 arranged so as to be adjacent to a heating element and the light receiving member 72 arranged so as to be spaced apart from the heating element, according to the difference in the thermal expansion.

Therefore, if a shading correction is performed using one shading correction data despite the different amount of relative positional shift occurring between the optical axis of the rod lens 68 and the light receiving member 72, due to the different temperature environment, an excellent correction may not be obtained.

For example, even if an output under the temperature environment of 0° C. is corrected using the shading correction data for solving the cycle of the output irregularity occurred under the temperature environment of 30° C., the amount of relative positional shift occurring between the optical axis of the rod lens 68 and the light receiving member 72 is different and the peak position of the cycle of the output irregularity shifts from the peak position of the temperature environment of 30° C., so that the excellent correction of the cycle of the output irregularity may not be realized.

Also, even if all of the light receiving members 72 are corrected using the same shading correction data, the temperature is different for each light receiving member 72, and there is a case where the peak position of the cycle of the output irregularity shifts for each light receiving member 72, so that the excellent correction of the cycle of the output irregularity may not be realized.

Therefore, as shown in FIG. 1, the image reading device 10 of this exemplary embodiment is provided with a memory unit 78 as a storage unit for storing the data of the shift of the cycle of the output irregularity occurring due to the different amount of relative positional shift between the optical axis of the rod lens 68 and the light receiving member 72 under the above-described temperature environments of 0° C., 30° C. and 60° C., as the shading correction data.

The light reflected from the reference white plate 65 to form an image by the lens array 70 is converted to the electric signal by the light receiving member 72, and a detecting unit 80 for obtaining the shift of the cycle of the light irregularity by the electric signal to detect the amount of relative positional shift between the light receiving member 72 and the lens array 70 based on the shift of the cycle of the light irregularity is provided.

Also, a correcting unit 82 for selecting the shading correction data suitable for each of the light receiving members 72 from plural kinds of shading correction data stored in the memory unit 78 based on the amount of positional shift detected by the detecting unit 80 and further correcting the electric signal converted by the light receiving member 72 based on the selected shading correction data is provided.

(Operation)

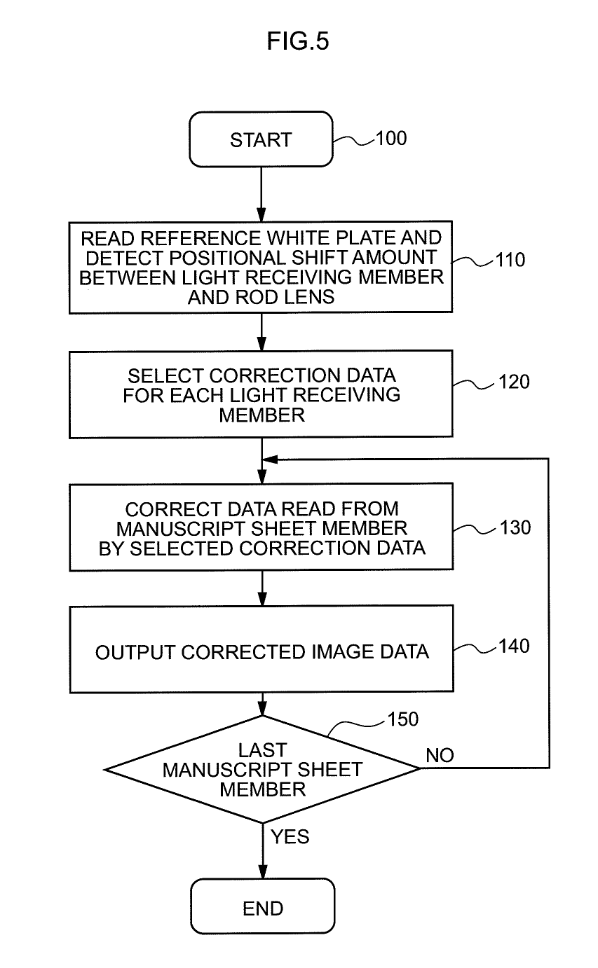

Next, the shading correction performed in the image reading device 10 will be described with reference to a flow diagram shown in FIG. 5.

First, at a step 100, a user presses a start button (not shown) for reading of a document surface of the document sheet member P put on a document tray 42 (see FIG. 3).

Next, at a step 110, before reading the image on the rear surface of the document sheet member P, the light source irradiates light to the reference white plate 65 (see FIG. 1), the light reflected from the reference white plate 65 to form an image by the lens array 70 is converted to the electric signal by the light receiving member 72, and the detecting unit 80 obtains the shift of the cycle of the light irregularity by the electric signal to detect the amount of relative positional shift between the light receiving member 72 and the lens array 70 based on the shift of the cycle of the light irregularity.

Next, at a step 120, the correcting unit 82 selects the shading correction data suitable for each light receiving member 72 from the plural kinds of shading correction data stored in the memory unit 78 based on the amount of positional shift detected by the detecting unit 80.

Next, at a step 130, the correcting unit 82 corrects the electric signal on the rear surface of the document sheet member P read by the light receiving member 72 to be converted on the basis of the selected shading correction data.

Next, at a step 140, the image data to which the shading correction is performed is output to the exposure device 112 through the substrate 76.

Next, at a step 150, it is judged whether the image data output to the exposure device 112 is the data of the last document, and when it is judged to be not the data of the last document, the procedure returns to the step 130, and when it is judged to be the last data, a series of processes are terminated.

In this manner, since the image data is corrected using the shading correction data stored in the memory unit 78, a mechanical system to allow the reference color plate to oppose to the image reader 62 or to retract the same for obtaining the shading correction data is not required.

Also, since the image data is corrected using the shading correction data stored in the memory unit 78, even if the reference white plate 65 is partially stained, this does not affect the shading correction.

The invention is described, in detail, for a specific exemplary embodiment. However, the invention is not limited to such an exemplary embodiment, and it is obvious for one skilled in the art that other various exemplary embodiments are possible without departing from the scope of the invention. For example, although the shading correction data corresponding to 0° C., 30° C. and 60° C. stored in the memory unit 78 are used in the above-described exemplary embodiment, the shading correction data for each 10° C. may be stored in the memory unit and used as the shading correction data.

Also, although read timing of the reference white plate 65 is set before reading of the document sheet member P in the above-described exemplary embodiment, the reading may be performed when turning on the power supply of the image forming apparatus or every predetermined time using a timer.

Also, although the image reading device 60 is used for reading the rear surface of the document sheet member P in the above-described exemplary embodiment, this may be used for reading the surface.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image reading device comprising:
a light source that irradiates light to a document;
an image forming unit comprising a plurality of optical members that receive reflection light reflected from the document and form an image from the received light;
a plurality of light receiving units that receive the light formed into an image by the image forming unit and convert the light to an electric signal;
a storing unit that stores a plurality of kinds of correction data used for correcting the electric signal converted by the light receiving unit;
a detecting unit that detects an amount of relative positional shift between a light receiving unit and the image forming unit for each light receiving unit; and
a correcting unit that selects correction data suitable for each light receiving unit from the plurality of kinds of correction data stored in the storing unit based on the amount of relative positional shift detected by the detecting unit, and corrects the electric signal converted by each light receiving unit based on the correction data.

2. The image reading device according to claim 1, wherein the detecting unit comprises:
an irradiated member irradiated with light from the light source; and
a detecting unit that obtains a cycle of light irregularity from the electric signal obtained by converting, at the light receiving unit, the light reflected from the irradiated member to form an image at the image forming unit, and compares this with a reference cycle of light irregularity, and detects an amount of positional shift between the light receiving unit and the image forming unit.

3. The image reading device according to claim 1, wherein the correcting unit performs shading correction on the electric signal converted by the light receiving unit.

4. The image reading device according to claim 2, wherein the correcting unit performs shading correction on the electric signal converted by the light receiving unit.

5. An image forming apparatus, comprising:
the image reading device of claim 1, and
an exposure unit that forms an electrostatic latent image according to image information on a surface of an image holding member based on image data read by the image reading device.

6. An image forming apparatus, comprising:
the image reading device of claim 2, and
an exposure unit that forms an electrostatic latent image according to image information on a surface of an image holding member based on image data read by the image reading device.

7. An image forming apparatus, comprising:
the image reading device of claim 3, and
an exposure unit that forms an electrostatic latent image according to image information on a surface of an image holding member based on image data read by the image reading device.

8. An image forming apparatus, comprising:
the image reading device of claim 4, and
an exposure unit that forms an electrostatic latent image according to image information on a surface of an image holding member based on image data read by the image reading device.
